(19) United States
(12) Patent Application Publication
(10) Pub. No.: US 2014/0233913 A1
(43) Pub. Date: Aug. 21, 2014

(54) CROSS-PLATFORM PORTABLE PERSONAL VIDEO COMPOSITING AND MEDIA CONTENT DISTRIBUTION SYSTEM

(71) Applicant: Rockwell L. Scharer, III, Los Angeles, CA (US)

(72) Inventor: Rockwell L. Scharer, III, Los Angeles, CA (US)

(21) Appl. No.: 14/261,878

(22) Filed: Apr. 25, 2014

Related U.S. Application Data
(63) Continuation-in-part of application No. 13/103,821, filed on May 9, 2011, now abandoned.

(51) Int. Cl. G11B 27/00; H04N 9/87

(52) U.S. Cl. CPC G11B 27/00; H04N 9/87
USPC 386/278; 386/338

(57) ABSTRACT

A method and a device are disclosed including a portable, collapsible neutral background screen and a portable computing device used to take a media clip against the neutral background screen to create and edit a finished media clip and upload the finished media clip via a computer network to an online performance venue for viewing, competition, and other actions by other participants and commercial entities. In some embodiments, the neutral background screen includes built-in speakers, lights and/or a drop-down microphone, which blend in with the neutral background screen.

### CROSS-REFERENCE TO RELATED APPLICATION

This application is a continuation-in-part of U.S. Non-Provisional Utility application Ser. No. 13/103,821, filed May 9, 2011, and claims the benefit of priority thereto.

### TECHNICAL FIELD

This application relates generally to video and audio applications. More specifically, this application relates to a portable, personal video compositing and media content distribution system using a Smart Phone and an optional portable video and audio background screen.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1; and

FIG. 3 shows an example personal media production system.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular computing devices like a Smart Phone, it will be appreciated that the disclosure may be used with other types of devices, such as a tablet PC, PDA, desktop or laptop computer with a camera and the like.

Briefly described, in some embodiments, a device and a method are disclosed including a portable, collapsible neutral background screen and a portable computing device used to take a video clip against the neutral background screen to create a finished media clip and upload the finished media clip via a computer network to an online performance venue for viewing, competition, and other actions by other participants and commercial entities. In some embodiments, the neutral background screen includes built-in speakers and/or a drop-down microphone, which blend in with the neutral background screen. In such embodiments, the device can record media content, which is defined throughout as video content, audio content, or a combination of video and audio content. Similarly, media files can be uploaded via a computer network to an online performance for viewing. In further embodiments, the video and/or audio content can be edited by users to their preference.

With the ubiquity of users' internet access, highly integrated devices, such as new Smart Phones having cameras capable of taking pictures and videos, and proliferation of online social networks, such as Facebook™, there is an ever increasing demand for high quality sharing of personal information and interactions such as video sharing, and the like. For example, Youtube™ is often used to post personal videos about almost any subject and to carry out video conversations or interactions between different people. However, the common methods used to take and post video online, such as using a common video camera and posting a video clip, can be cumbersome, time consuming, and limited in their capabilities, such as high quality background selection.

### Illustrative Operating Environment

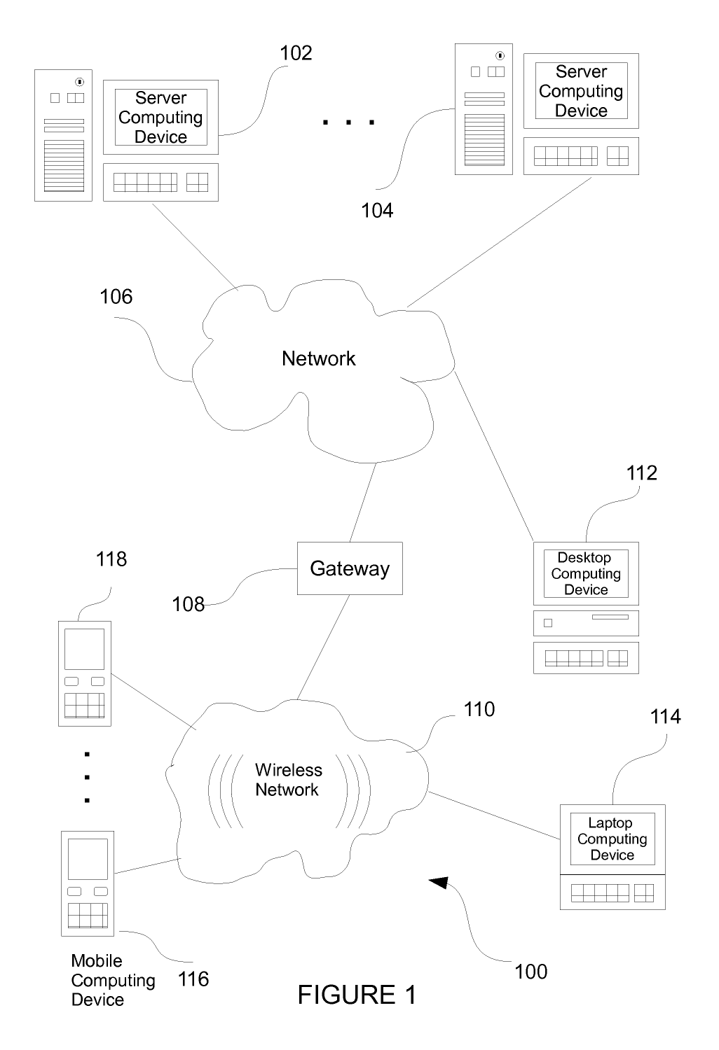

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

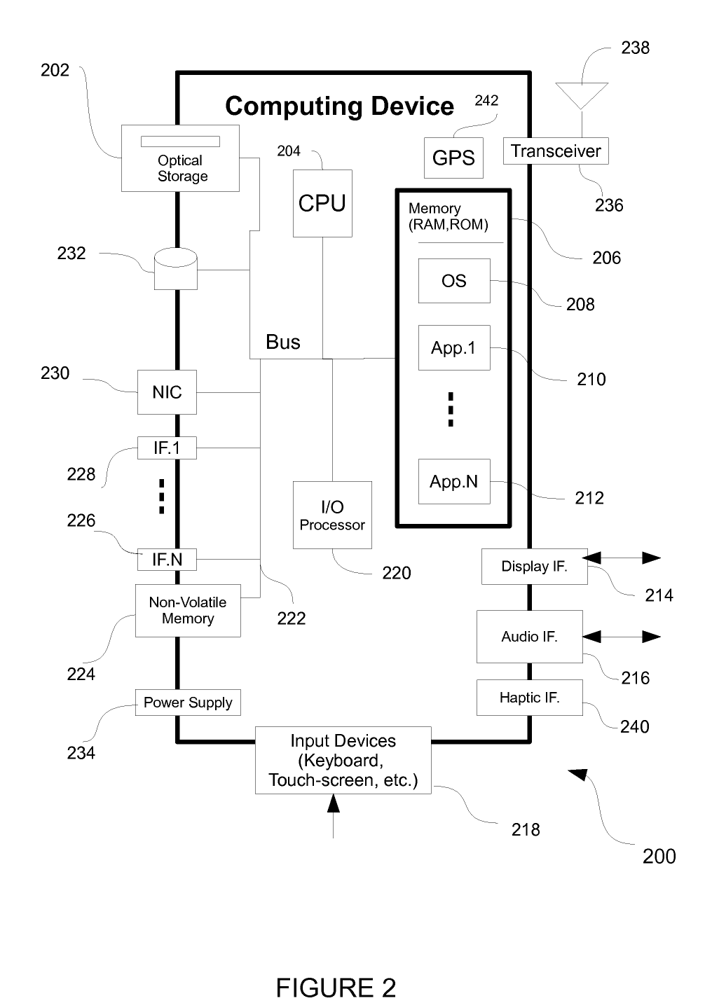

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, digital cameras, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, and the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4^{th} (4G), generation and any future generation technologies for radio access for cellular systems, WLAN, Wireless Router (WR) mesh, and the like. Access technologies such as 3G, 4G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), HDMI (High Definition Multimedia Interface), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

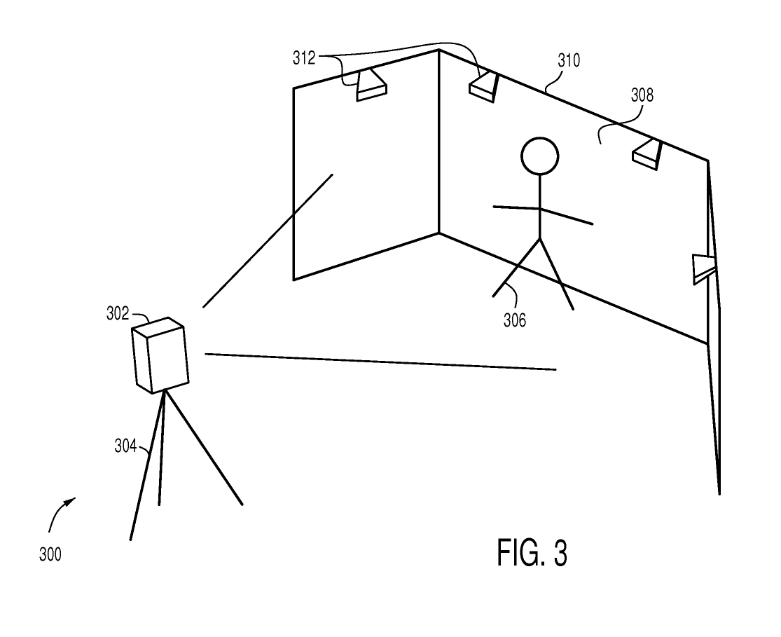

FIG. 3 shows an example personal media production system. In various embodiments, media recording arrangement 300 includes portable computing device 302, mounted on a frame or tripod 304, configured to record a video clip of user 306 against neutral background screen 308, supported by frame or cage 310. Cage 310 may include microphones and/or speakers 312 to record an audio clip of user 306 and/or play back audio, respectively.

In various embodiments portable computing device 302 may be one of the client devices described above with respect to FIG. 2. For example, portable computing device 302 may be a Smart Phone, a digital camera, a tablet PC, a desktop or laptop computer with a camera, and the like. In various embodiments, a software video recording and processing application (VPA) may be used to record and/or process video recorded by the computing device. In some embodiments, the VPA is downloaded and used on the computing device to record and process the video clip of the user, while in other embodiments, the computing device records the video and sends it to a server computing device for processing using VPA resident on the server computing device. Still in other embodiments, the video clip is recorded by the computing device and web services implementing functionality of the VPA are used to process the video.

In various embodiments, the VPA includes various sub-applications (sub-app), sometimes in the form of various interfaces, focused on specific tasks. In some embodiments, the VPA is divided into a creative sub-app configured to help users create audio and/or video content; an interactive sub-app configured to be used for real-time interaction with other parties and entities involved in the production and/or performance of recorded video clips, as further described below; an educational sub-app configured to be used in sharing creative content with others in a learning environment; a competitive sub-app configured to be used in sharing content with others in gaming applications; and a sponsor sub-app configured to enable producers, subscribers, and sponsors to interact with users.

In various embodiments, the sub-applications of the VPA may be utilized by other entities, as further described below, as interactive functions between the parties involved. In such interactive functions, one party or entity may initiate an action, which is continued or completed by another collaborating party or entity. For example, one party may create a raw video clip and initiate an interactive function with another entity to add audio to the video clip and pass it on to another entity to perform other processing on the video clip, such as adding editing or adding a background.

With continued reference to FIG. 3, in various embodiments, neutral background screen 308 is a solid green or blue screen suitable for Chroma key compositing (or chroma keying), which is a technique for compositing two images in which a predetermined color from one image is made transparent, revealing the other image behind it. Chroma key compositing is commonly used for action movies or weather forecast broadcasts, wherein the actor or presenter appears to be standing in front of a background, which is actually a large blue or green background in the filming or broadcast studio. The actor stands in front of a blue screen or green screen, and then different backgrounds are added on those parts in the image where the color is blue. Blue and green colors are used because they are considered the colors least like skin tone. In some embodiments, a set of “green screen” functions of the creative sub-app may be used to substitute the different backgrounds for the neutral (green or blue) background on the screen. The substituted different backgrounds may be selected by the user from a set of available backgrounds on the computing device, downloaded from a video service, provided by a third party, or any other source.

In various embodiments, neutral background screen 308 is foldable for easy personal transportation. In some embodiments, neutral background screen 308 is composed of multiple pieces to provide a surround effect for the background, while in other embodiments, the screen has a single piece, which can be curved to provide the surround effect. In some embodiments, neutral background screen 308 is deployed with frame or cage 310 having accommodations for attaching microphones and/or speakers 312 to the scene for playing and recording sounds during filming. Such speakers and microphones may have the same color as the background screen to allow digital removal of their image from the video clip. In some, the cage is integrated with the background screen, while in other embodiments the cage is set up separately from the screen.

In various embodiments, a video clip is produced for public and/or private viewing in cooperation with various parties and entities. Such parties may include a network of content creators, distributors, advertisers, media access points, content hubs, and partnerships between these and other parties, as further described below. In various embodiments, users can utilize the Media Audition Submission System or M.A.S.S. Network™, which functions as a cross-platform media hub to provide video or audio clips for public or private viewing to various parties and entities, such as YouTube™, Hitmakers™ television series, modeling agencies, recording studios, etc. Various functions of VPA, as described above, may be used and/or initiated by various parties. For example, some interactive functions may be initiated by the network of content creators, while other interactive functions may be initiated by other third party media producers. Third party media producers may include TV, film, theatrical, and radio production companies, webcast producers, event organizers, concert promoters, or any entity that creates programming or events that may use media content.

Some interactive functions of the VPA may be initiated by third party marketing or advertising sponsors and their content producers, in conjunction with the network of content creators or other third party networks. These third party sponsors may include product manufacturers, retail stores, advertising agencies, market research agencies, or any entity that may use media content to generate revenue.

Some interactive functions of the VPA may be initiated by third parties subscribing to the network of content creators for the purpose of co-creating content or acquiring talent or content. These third party subscribers may include talent agencies, production companies, employers, entertainment venues, casting agents, news agencies, content providers, or any entity that seeks to acquire talent or content.

Some interactive functions of the VPA may be initiated by a user in association with the network of content creators or third parties for the purpose of creating content or acquiring talent. For example, a producer may be looking for editing talent. A raw video clip may be downloaded to a user who is a candidate as a film editor. The user edits the video clip and uploads the edited video back to the producer for evaluation. In effect, this interaction functions as an interview or test for hiring an editor.

Some interactive functions in VPA may be initiated by a contestant using an account associated with the network of content creators and/or third party for the purpose of responding to a particular request for such content in a competitive environment.

In various embodiments, in operation, with continued reference to FIG. 3, user 306 uses portable computing device 302 to record video and/or audio against neutral background screen 308. The VPA may be used to change the solid color background of the background screen with another background from an archive or another media file. Many scenarios may use the media recording arrangement 300 at different stages of content production and for different purposes as further described below. In further embodiments, users can edit produced content with a background already recorded.

In various embodiments, the VPA's content distribution sub-app interface allows users to share content with the content creation network and other third party networks. The content distribution interface allows user to control privacy settings associated with the content. Content, complete or incomplete, may be uploaded to a content distribution website or hub operated by the content creation network. The network hub provides a central location, which serves to distribute content to, or receive content from multiple end-users. End-users may include, but not be limited to audition services, film/television production companies, contest submissions, news organizations, marketing services, political organizations, educational institutions, and job placement services.

In other various embodiments, contents so produced by media recording arrangement 300 may be shared on various social networks, such as Facebook™, MySpace™, and YouTube™. The sub-app's content distribution interface may allow users to share content directly with certain websites. The content distribution interface may further allow users to control privacy settings associated with the content. In various embodiments, the content distribution sub-app may access profile information stored on social network sites, depending on user-defined privacy settings, and can be synchronized with corresponding user profiles on the content creators' network.

In various embodiments, the sub-app's content distribution interface allows users to share content with subscribers seeking talent. Potential buyers of talent or content may subscribe to content creators' network for the purpose of acquiring talent or content of all kinds. Subscribers may issue requests in the form of challenges or descriptions for specific talent or content needed. Subscribers may provide pre-recorded audio or video for use by user in the creation of content requested by subscriber. Subscriber may upload provided content to the content creators' network hub, which in turn distributes that content to users. Users may fulfill subscriber or sponsor requests by creating and submitting content back to the content creators' network hub, which in turn distributes that content back to subscribers or sponsors. Examples of subscriber-initiated events may include, but not be limited to auditions, contest entries, employment opportunities, job interviews, webcasts, news reports, educational programming, marketing, testimonials, depositions, or any other situation in which media content or talent is used.

In various other embodiments, the sub-app's content distribution interface allows users to share content directly with other users or with anyone with the ability to receive digital media via email, FTP (File Transfer Protocol), or any data transfer facility. Content distribution interface may allow user to control privacy settings associated with the content. Content distribution interface may allow users to access contacts stored in the portable computing device's internal contact database for the purpose of direct sharing.

In various other embodiments, the VPA or its sub-app include a control panel for remote data exchange with other computing devices and interaction with media events created by the content creators' network or created by third parties (for example, producers, subscribers, or sponsors) in conjunction with content creators' network. The control panel may feature tools that allow the user to participate, along with other users, in real-time or off-line, in collective and/or multi-user media events, including but not limited to TV and web broadcasts, marketing events, or non-digital live events, such as a high school football game. One of the components of the control panel may be assignable, scalable, multi-dimensional data entry units that allow the user to submit a rating or a vote on a sliding scale, allowing for weighted “smart” votes. These data entry units may be implemented using software components and constructs such as virtual knobs, sliders, switches, buttons, or any other appropriate form, as defined by producers. In some embodiments, control panel tool sets and data buckets may be created by the third parties, using the programmable data entry units provided by the control panel. These tools sets will allow producers, subscribers, and sponsors to define specific tool sets to work interactively with the events they have created.

In various embodiments, producers may wish to incorporate interactivity into their media programming events, allowing viewers to participate in programs and events. The control panel allows for producers to submit inquiries for public user interaction of all kinds, as needed by specific events. These inquiries may be in the form of challenges requesting user input to refine and complete downloaded projects, or requests for user opinions, votes, or feedback to affect the outcome of an event. Examples of producer-initiated interactive events may include, but not be limited to voting for competition shows, participation in games, auctions, opinion polls, input determining program content, or any other instance in which producers may need public input for their media programming.

In various embodiments, the VPA or its sub-apps include the ability for sponsors and advertisers to send promotional and marketing material to the mobile devices. Sponsors may post passive advertisements, or they may incorporate their advertisements into interactive events. In conjunction with content creators' network, sponsors may incorporate products, advertisements, or other marketing strategies into media programming events. Sponsors may then define the sub-app's control panel using their own data sets (i.e. populating specific buckets of data a subscriber or producer wishes to use for interaction), allowing for public user interaction involving their products or data for mining preferences, and the like. Sponsors may include control panel links to request information or to purchase products directly. Sponsors will be able to target market their users geographically, using GPS functions in the mobile device, if available. GPS availability is user-controlled through privacy settings. Sponsors may include revenue-generating functions in the form of “click-through” links to advertisers, sales, discounts, co-brands, or rebates, which may be tracked for data mining through content creator's network hub. Examples of sponsor-initiated interactive events may be targeted advertising, market research, focus groups, consumer data collection, product evaluation, direct product sales, or any other instance in which consumer input is needed.

In various embodiments, the control panel allows user to set up and distribute interactive multimedia educational materials. Access to educational materials may be limited by administrative user and will include privacy control. Examples of educational use include lectures, virtual classroom assignments with live or off-line interaction, discussion groups, master classes, private instruction, or multimedia blackboards exchanging all types of media content.

In various embodiments, the content creators' network or third parties may at times sponsor online competitions through the content creators' network Hub accessible via a website or URL. Content created by users may be submitted for entry by uploading to the content creators' network hub. Content may be judged by the public users, using the interactive control panel to submit Smart Vote™ and determine winners. The VPA may include the ability to share content with video game creators for real-time competition with other Users. The video may be used in a preview mode (for example, live camera—unrecorded) to stream to video game interfaces, where video content may interact with games. In some embodiments, chroma-key functions allow users to insert themselves into the video game background, combine imaging with other players, or create one-on-one competitions with each player seeing and competing against the opponents'chroma-key image.

In various embodiments, the VPA may include a quick-start guide to assist first-time users. The VPA may include a link to full user's manual available on content creators' network website. The VPA may further include limited Frequently Asked Question (FAQ) file, while the website includes expanded or complete FAQ. The VPA may further include links to tricks & tips page on content Creator's network website where users can freely exchange ideas on a user Forum.

As illustrative examples, how groups of participants may work together is examined. As an example, a revenue model using the VPA is examined, where three participants, a producer, a sponsor, and a user collaborate in an event utilizing some of the VPA's elements described above including media programming, smart voting, and marketing. In this example, the producer, such as the content creators' network, creates a television show called Hitmakers™. A sponsor, such as a department store creates a marketing event to be a part of Hitmakers™. The department store pays content creators' network for the use of the interactive control panel of the VPA, and creates a custom tool set to allow users to send data to the content creators' network hub. During the course of the Hitmakers™ broadcast, the department store issues a series of challenges or input requests that the users may respond to from their mobile device. For example, the department store might provide clothing for the contestants on Hitmakers™. As the various outfits appear on screen, the department store asks users to vote on their likes and dislikes. Users are able to respond with scalable Smart Vote™ to rate the clothing they see. As the votes are submitted, the user is rewarded for their participation with pop-up items that appear on their mobile device. These rewards might be in the form of discount coupons, or points that may be redeemed toward purchases. The department store may also build hot buttons into the tool set that allow users to instantly purchase items directly, or request information.

By creating an interactive marketing event, the department store is able to collect a large amount of targeted marketing data, including consumer opinions and demographics, and can generate revenue through direct or future sales. Users benefit through rewards, and through a more enjoyable media experience. And content creators' network generates revenue through click-throughs as users respond to the department store requests.

As another example, a broadcast programming model utilizing the VPA is examined. In this example, a producer, such as content creators' network, creates a reality-based show for web broadcast. The premise of the show is to issue creative challenges to users so that users can complete projects, such as music videos, and submit them for online competition. The producer has specific requirements to complete the challenge, presented on a challenge website, and provides users with media content, such as a video background image, that is used in the challenge. The producer pushes or downloads the content out to one or more users, for example, by sending the content to the users' mobile devices. Each user creates a new version of the video using the downloaded content. The users may choose to collaborate with other users by sharing content directly. When videos are complete, each user submits it to the hub, where the producer can pull or upload the content back to the challenge website.

In creating the videos, the content creation elements of the VPA are used, including the creative sub-app or green screen functions to insert the background image provided by the producer in place of the neutral background presented by the screen. The submitted videos are broadcast on the web, and various users log in to vote on the best entries. The producer has created a custom tool set in the control panel that works with their webcast, and users access the control panel to submit their Smart Vote™ and determine winners for each round. As competition enters the later rounds, the producer migrates the web-based show to conventional TV for a broader audience.

As another example of a business model utilizing the VPA, a local broadcast news station is examined. In this example, the local broadcast news station is looking for new talent for the weather segment. The station access an “Employment Opportunities” section on the content creators' network hub and issue a “Job Opening” notice, asking potential talent to submit audition videos. The Job Opening notice is instantly sent by mobile device to all users who have created an account with content creators' network indicating their interest in a broadcast career. To assist in the audition videos, the station provides a background image of a newsroom weather map. Using the green screen functions of the creative sub-app, applicants insert themselves into the newsroom and record their audition. By using the VPA to create the video, applicants are better able to show their ability to perform in the context defined by the station, increasing the chance that the employer will find the best candidate for the job.

As another example, an educational model utilizing the VPA is examined. In this example, online classes in multi-media production are offered by a university. To connect to the students, the teacher creates a private “Virtual Classroom” on the content creators' network hub, accessible through the VPA on the students' mobile devices. As part of the curriculum, the teacher posts classroom exercises on a ‘Virtual Blackboard’, including multi-media content—audio, video, or data—for use in exercises, and virtual lectures. As class material is posted, students receive notices on their mobile devices. The students then retrieve content, complete assignments using the content creation function in the VPA, and post them back to the hub for evaluation.

For group assignments and discussion groups, students use the video functions of the VPA to create conferences, where teacher and student can work together ‘face-to-face’ in real time. Periodically, the teacher posts tests on the hub. By creating a custom tool sets, the teacher can design a timed test so that students answer questions or solve problems in real time, as the questions pop up on their device. Since the Virtual Classroom exists on the content creators' network hub, it can be accessed anywhere, making the educational model useful for non-profit organizations that reach out to developing countries. By enabling underprivileged students to collaborate with students in developed nations, the VPA will increase their ability to learn and compete on the world stage.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A software application, that when executed on a computing device causes the computing device to:
provide a creative function configured to record a media clip against a neutral background; and
substitute a different background for the neutral background to create a finished video.

2. The software application of claim 1, comprising a plurality of sub-applications.

3. The software application of claim 2, wherein the plurality of sub-applications include a creative sub-application, an interactive sub-application, a competitive sub-application, and a sponsor sub-application.

4. The software application of claim 3, wherein the creative sub-application is used to substitute the different background.

5. The software application of claim 3, wherein the interactive sub-application is configured to allow interaction between a user of the computing device and viewers of the finished video.

6. The software application of claim 3, wherein the competitive sub-application is configured to allow competition between game players.

7. The software application of claim 1, wherein the computing device is a Smart Phone.

8. The software application of claim 1, wherein the neutral background is one of a blue screen and a green screen.

9. The software application of claim 1, further comprising a control panel configured to exchange data with other computing devices to allow users to participate in collective media events.

10. The software application of claim 1, that when executed on the computing device causes the computing device to provide a smart voting function.

11. A media recording system comprising:
a portable background screen
an audio recording device; and
a software video and audio application configured to execute on a portable computing device.

12. The software application of claim 11, wherein the portable background screen is a foldable green or blue screen configured to provide a neutral background for video recording.

13. The software application of claim 11, wherein the portable computing device is a Smart Phone.

14. The software application of claim 11, wherein the software media application comprises a plurality of sub-applications.

15. The software application of claim 14, wherein the sub-applications include a creative sub-application, an interactive sub-application, a competitive sub-application, and a sponsor sub-application.

16. The software application of claim 11, wherein the software media application is configured to substitute a different background for an original video background.

17. A method of skill evaluation, the method comprising:
receiving a media clip of a performance, wherein the media clip is recorded by a portable computing device using a software media application configured to record an audio clip and substitute a different background for an original background of the video clip; and
evaluating the performance based on the received media clip.

18. The method of skill evaluation of claim 17, wherein receiving the media clip comprises receiving the media clip from a content creators' network hub.

19. The method of skill evaluation of claim 17, wherein the software media application comprises a plurality of sub-applications.

20. The method of skill evaluation of claim 17, wherein portable computing device is a Smart Phone.
